(19) United States
(12) Patent Application Publication
(10) Pub. No.: US 2017/0057885 A1
(43) Pub. Date: Mar. 2, 2017

(54) PROPELLANT LOAD, WITH MECHANICALLY REINFORCED LINER/PROPELLANT CONNECTION, AND PREPARATION THEREOF

(71) Applicant: AIRBUS SAFRAN LAUNCHERS SAS, Issy-les-moulineaux (FR)

(72) Inventors: Nancy DESGARDIN, Bouray (FR); Claire BOUCHAUDY, St Medard En Jalles (FR)

(21) Appl. No.: 15/120,177

(22) PCT Filed: Feb. 20, 2015
(86) PCT No.: PCT/FR2015/050420

§ 371 Date: Aug. 19, 2016

(30) Foreign Application Priority Data
Feb. 20, 2014 (FR) 1400453

(51) Int. Cl. C06B 45/12; F02K 9/34

(52) U.S. Cl. CPC C06B 45/12; F02K 9/346

(57) ABSTRACT

A propellant load includes a propellant block, containing energetic charges in a crosslinked binder, arranged in a structure having a thermal protection; the crosslinked binder being an energetic binder including a polymer, more polar than hydroxytelechelic polybutadiene (HTPB), which is crosslinked and an energetic plasticizer, the polymer non-crosslinked representing less than 14% of the volume of the propellant block; a bonding layer, based on crosslinked hydroxytelechelic polybutadiene (HTPB), between the thermal protection and the propellant block; and a system for mechanical reinforcement of the bonding layer/propellant block bond, present on at least part of the bonding layer/propellant block interface, including grains embedded in part in the bonding layer and the complementary part thereof being embedded in the propellant block: made of a pyrotechnically inert material, and that has a surface energy greater than 34 mJ/m²; and the largest dimension of which is between 0.3 and 5.2 mm.

The present invention relates to (solid) propellant loads with mechanically reinforced liner (bonding layer)/propellant bond. It also relates to a process for preparing said loads.

The loads of the invention are optimized with reference to the strength of the bond: liner (bonding layer)/propellant.

The loads in question are of molded-bonded type.

Those skilled in the art know the use that is opportunely made, within this context, of a bonding layer (of a liner) between the propellant (more precisely the propellant block) and the wall, more generally the thermal protection of the wall, of the structure (such as a combustion chamber of a thruster) that contains said propellant. Said bonding layer aims to perfect the adhesion of said propellant (propellant block) to said wall, and therefore more generally to said thermal protection of said wall, this thermal protection itself being attached to said wall.

The liner (bonding layer)/propellant bond is conventionally obtained by chemical mechanisms:
interdiffusion of the chains of polymer(s) and co-crosslinking (very particularly when polymers of the same type (hydroxytelechelic polybutadiene (HTPB), generally) are present in the binder of the propellant, on the one hand, and in the liner, on the other hand); and, opportunely, in addition,
integration of adhesion promoters into the liner, which diffuse and react within the propellant.

However, these chemical mechanisms do not always make it possible to obtain satisfactory levels of adhesion (levels of adhesive bonding).

It has thus been recommended to turn, in addition, to mechanical methods based on the anchoring of embedments between the liner and the propellant.

The embedments in question may be pyrotechnically active embedments, in particular based on nitrocellulose. The use of embedments of this type has been described within the context of nitrocellulose-nitroglycerin double-base propellants, in particular in patents U.S. Pat. No. 3,965,676, U.S. Pat. No. 4,441,942, U.S. Pat. No. 4,530,728 and U.S. Pat. No. 4,654,103. The use of embedments of this type—which are pyrotechnically active—represents a significant constraint, from which it is opportune to be free, very particularly within industrial facilities.

The embedments in question may be embedments that are not pyrotechnically active, inert embedments. Patent U.S. Pat. No. 3,965,676, identified above, also mentions, within this context of double-base propellants, inert embedments, of the type of cellulose acetate grains, methyl cellulose grains, ethyl cellulose grains, benzyl cellulose grains, polystyrene grains, polyvinyl chloride grains, polymethyl methacrylate grains. These grains are capable of absorbing nitroglycerin (or any other nitrated oil present in the composition of the propellant), of thus swelling and of then losing their mechanical properties, proving to be, over time, incapable of carrying out their adhesion-reinforcing role.

Patent U.S. Pat. No. 4,337,218 itself describes pre-existing inert structures—of more or less complex shapes, which have regularly distributed protrusions (that can be likened to embedments)—to be integrated therefore between the liner (the bonding layer) and the propellant. These inert structures are very particularly described within HTPB (liner)/HTPB (propellant binder) bond contexts. Such inert structures must obviously be prepared beforehand. The handling thereof and more particularly the deposition thereof between the liner and the propellant may prove tricky, difficult to industrialize, in particular for loads of complex geometry.

To date, novel types of propellant (Oxalane®, Azalane®, very particularly) have been developed. In order for them to produce a maximum power, their composition contains:
an energetic binder, comprising a (low content of) polymer and a (high content of) energetic plasticizer (generally a nitrated oil, capable of migrating toward the liner, to swell it and therefore to be detrimental to the liner/propellant adhesion); and
a high charge content (i.e. a low binder content).

The required polymer/(energetic) plasticizer miscibility necessitates a polymer other than HTPB, a polymer more polar than HTPB. Reference may be made to a polar polymer insofar as HTPB is virtually nonpolar. Reference is made to HTPB, generically, insofar as HTPB, irrespective of its molecular weight, is virtually nonpolar (HTPBs, considered independently or as a mixture, are virtually nonpolar).

These novel types of propellant cannot be used with liners based on the same types of (polar) polymer, with reference to the technical problem of the migration of the plasticizer that is highly damaging to the strength of their liner/propellant bond.

It is therefore strongly recommended to use them with conventional liners, especially since said conventional liners, based on HTPB, have many advantages: their adhesion to the thermal protection is satisfactory, their mechanical properties are also satisfactory and they absorb nitrated oils very little.

The (polar) polymer/conventional (HTPB) liner adhesion is however a real technical problem. The polymers in question (polar polymer, on the one hand and HTPB, on the other hand) have hardly any affinity and, above all, the polar polymer, as indicated above, is present at a low content in the propellant composition.

The low level of adhesion (propellant with (polar) polymer/HTPB) has been quantified by the inventors. Thus, the degree of peel between a standard HTPB liner arranged on a conventional thermal protection based on ethylene-propylene diene monomer (EPDM) and an Oxalane® X propellant with PDEGA (poly(diethylene glycol adipate)) binder is 0.4 daN/cm, whereas the quality criterion imposes a minimum value of 1.3, preferably 1.5, daN/cm for strategic applications.

Faced with this real technical problem, the inventors propose an efficient solution based on the intervention of mechanical reinforcement means of embedment type. It was in no way foreseeable that a solution of this type would prove efficient in such a difficult context, that of the effective reinforcement of an intrinsically weak adhesion between a conventional HTPB-based liner and a propellant with a low content of polar (≠HTPB) polymer.

According to its first subject matter, the present invention therefore relates to a propellant load (propellant for which the (polar) polymer is other than HTPB) within which the bonding layer (HTPB)/propellant block level of adhesion is satisfactory owing to the presence of specific embedments.

Conventionally, said propellant load comprises:
a propellant block, containing energetic charges in a crosslinked binder, arranged in a structure of a substantially cylindrical shape with a sleeve, a rear end and a front end; said structure having a thermal protection attached to its inner face, opposite said block;
a bonding layer (=a liner), based on crosslinked hydroxytelechelic polybutadiene (HTPB), between said thermal protection and said propellant block; and
means for mechanical reinforcement of the bonding layer/propellant block bond.

In this regard, it is a load of conventional type with structure (generally made of a metallic or composite material), comprising a thermal protection attached to its inner face and containing a propellant block, stabilized in its internal volume via a bonding layer (a liner) made of crosslinked HTPB (generally crosslinked with polyisocyanate-type crosslinking agents). A person skilled in the art is aware that the shapes of said block and structure coincide. The bonding layer/propellant (propellant block) bond is mechanically reinforced (for an optimization thereof, i.e. for a perfect adhesive bonding (a perfect adhesion) of the bonding layer/propellant (propellant block)).

The thermal protection, generally based on an elastomer (on a gum rubber or on a liquid elastomer), such as an EPDM (ethylene-propylene-diene monomer) rubber, is attached, in a conventional manner, to the inner face of the structure. Such an attachment is carried out upstream, generally by adherisation of a thermal protection to the inner face of a pre-existing metallic structure, by drape forming or by spraying, or following the generation of the structure made of a composite material by winding around a thermal protection. A person skilled in the art knows these techniques for obtaining the desired structure (in which the bonding layer and the propellant block will subsequently be generated): structure of a substantially cylindrical (axisymmetric) shape, with a sleeve, a rear end and a front end and comprising a thermal protection attached to its inner face. It is specified here, in case it may be of use, that the inner face of the structure corresponds to the inner face of the sleeve, of the rear end and of the front end of said structure.

Characteristically, the propellant load of the invention combines specific mechanical reinforcement means (see below) with a specific propellant (see above and below).

Characteristically:
the crosslinked binder of the propellant block is an energetic binder comprising a polymer, more polar than hydroxytelechelic polybutadiene (HTPB), which is crosslinked and an energetic plasticizer, said polymer (non-crosslinked) representing less than 14% of the volume of the propellant block; and
said means for mechanical reinforcement of the bonding layer/propellant block bond, which are present on at least one portion of the bonding layer/propellant block interface, comprise individualized grains embedded in part in said bonding layer and the complementary part thereof being embedded in said propellant block:
made of a pyrotechnically inert material that is unreactive with respect to the bonding layer and also with respect to the propellant, and that has a surface energy greater than 34 mJ/m², advantageously greater than 40 mJ/m²; and
the largest dimension of which is between 0.3 and 52 mm, advantageously between 1.7 and 3.5 mm.

As regards the energetic binder of the propellant, mention has been made of “a” polymer and “a(n)” (energetic) plasticizer. Generally, a single plasticizer is combined with a single polymer, but it could not be excluded, within the context of the invention, for several polymers and/or several energetic plasticizers (miscible with one another) to be present in the composition of the propellant. “A” polymer should therefore be read as “at least one” polymer and “a” plasticizer should therefore, in the same way, be read as “at least one” plasticizer. As indicated above, the propellant of the load of the invention is therefore a propellant with a (crosslinked) energetic binder [(crosslinked) energetic binder=(crosslinked) polymer (polymer, other than HTPB, that is implicitly polar, more polar in any case than HTPB(s) (in view of its miscibility with the energetic plasticizer))+energetic plasticizer (potentially detrimental to the liner/propellant adhesion)] that contains a low content of (non-crosslinked) polymer (<14% by volume), therefore a high content of charges and of plasticizer. The (non-crosslinked) polymer is generally present at at least 8% by volume. As regards the plasticizer, the propellant generally contains less than 27% by volume, very generally less than 27% by volume and at least 10% by volume thereof. These numbers will not surprise a person skilled in the art who knows this type of propellant. It is recalled here, in case it may be of use, that the invention does not lie in the nature of the propellant, which is known per se, but proposes loads of this type of propellant, that are perfectly stabilized in their structure owing to the intervention of effective embedments between the propellant and a conventional liner of HTPB type.

With such a propellant and a conventional bonding layer (based on crosslinked HTPB), the means for mechanical reinforcement of the bonding layer/propellant (propellant block) bond, as characterized above, have proved effective.

Said means, present on at least one portion of the bonding layer/propellant block interface (on one portion only of said interface (advantageously, logically, in the areas where the propellant is the most constrained) or on the whole of said interface), comprise (generally consist of) individualized grains (it is not a question of prefabricated devices or structures) embedded in part in said bonding layer and the complementary part thereof being embedded in said propellant (propellant block). Said grains (“point embedments”) are characterized

1) by their constituent (mineral or organic) material that is:
pyrotechnically inert,
unreactive (i.e. it does not react chemically and does not absorb the plasticizer(s)) with respect to the bonding layer and also with respect to the propellant (=with respect to the energetic binder=with respect to the crosslinked polymer and with respect to the energetic plasticizer), and
that has a surface energy greater than 34 mJ/m², advantageously greater than 40 mJ/m² (this “surface energy” parameter of a material is familiar to a person skilled in the art. It is calculated from the measurement, by goniometry, of the contact angle between the surface of said material and drops of various liquids); and
   2) by their size: their largest dimension is between 0.3 and 5.2 mm, advantageously between 1.7 and 3.5 mm.

The constituent material of the grains [(unreactive with the materials present (constituent materials of the propellant and constituent materials of the bonding layer) and having a suitable surface energy (ensuring a good adhesion to the interfaces of the grains)] and the sufficient size of said grains make it possible to obtain the desired anchoring effect (the desired adhesion reinforcement), having a suitable intensity within this difficult context (of adhesion between a crosslinked HTPB and an energetic crosslinked binder, containing a crosslinked (polar) polymer present in a small amount).

The size of the grains is opportunely limited with reference to the thickness of the bonding layer.

The grains may in particular be cylindrical, cubic or spherical (advantageously having, respectively, a length, edges, and a diameter between 0.5 and 3 mm, very advantageously between 1 and 2 mm). They may be of any shape, in particular if they are obtained by milling. Their largest dimension is, in any case, as specified above.

Proposed below are several nonlimiting clarifications regarding the nature of the propellant of the loads of the invention and regarding the novel mechanical reinforcement means that are recommended.

The propellant in question is therefore a propellant with a (crosslinked) energetic binder, said energetic binder comprising a polar polymer (that is crosslinked, generally with polyisocyanate-type crosslinking agents) and an energetic plasticizer.

The polymer (that is polar, more polar than HTPB) is advantageously an oxygen-containing polymer, in particular an oxygen-containing polymer selected from polymers of polyethylene glycol (PEG) type, of polycaprolactone type, of polytetrahydrofuran (pTHF) type, of polypropylene glycol (PPG) type, of poly(diethylene glycol adipate) (PDEGA) type, of glycidyl azide polymer (GAP) type, and copolymers thereof. It is very advantageously of poly(diethylene glycol adipate) (PDEGA) type and/or of glycidyl azide polymer (GAP) type. It consists preferably of a polymer of one of these two types: PDEGA or GAP.

It is recalled that “a” polymer is read, in the present text, as “at least one” polymer.

The energetic plasticizer advantageously consists of a nitrated oil. It consists, for example, of a nitric ester, such as nitroglycerin.

In the same way, it is recalled that “a” plasticizer is read as “at least one” plasticizer.

The charges consist, in a manner known per se, of oxidizing or energetic charges (ammonium perchlorate, potassium perchlorate, ammonium nitrate, octogen, nitroguanidine, mainly and ammonium perchlorate, generally) and, optionally reducing charges (aluminum, generally). Said charges are therefore present in a high content (generally of more than 70% by weight).

The propellant in question is advantageously an Oxalane® or Azalane® propellant.

As regards the grains, their constituent material is advantageously selected from polyamide-6, silicon carbide, Kevlar (poly(p-phenylene terephthalamide) (PPD-T)), alumina, melamine resins and urea-formaldehyde resins. It consists very advantageously of polyamide-6 or silicon carbide.

The table below (excerpt from: “Adhesion and Adhesives, Science and Technology, by A. J. Kinloch, first edition, London 1987, p. 24) is proposed, in case it may be of use.

TABLE 1

| | Surface |
|---|---|
| | energies |
| Ingredients | (mJ/m²) |
| Kevlar | 43.7 to 47 |
| Alumina | 169 to 638 |
| Polyamide-6 | 41.4 |
| Polyethylene | 32.4 |
| Urea-formaldehyde resin | 61 |
| Polycarbonate | 34.2 |
| Melamine-formaldehyde resin | 58 |
| Cellulose acetobutyrate (CAB) | 34 |
| EPDM | 32.5 |
| Silicon carbide (SiC) | 220 to 34 000 |
| Nitrocellulose | 42.7 |

The numbers indicated in this table confirm that the mineral embedments (already pyrotechnically inert and unreactive) have high surface energies (which may in fact vary as a function of the level and of the type of crystallization) that are therefore advantageous from the point of view of the invention.

The apolar polymer embedments such as polyethylene (more generally hydrocarbon-based polymers) have a low surface energy. They are not very or not at all advantageous from the point of view of the invention.

Other polymers (CAB, . . . ) might be acceptable or borderline acceptable due to their surface energy but, due to their ability to absorb the nitrated oils (to lose their mechanical properties), they are excluded.

It is seen that nitrocellulose has a sufficient surface energy. However, this pyrotechnically active material is excluded.

It was indicated above that the grains of the invention—means for mechanical reinforcement of the liner/propellant bond—are very advantageously silicon carbide grains (see the advantageous surface energy values of SiC) or polyamide-6 grains (said polyamide-6 being commercially available in several geometric shapes, in particular in the shape of cylinders). It is advisable to include silicon carbide grains and/or polyamide-6 grains.

Generally, it should be understood that the grains present at the liner/propellant (propellant block) interface are not necessarily all identical. They may be made of at least two suitable materials (that are pyrotechnically inert, unreactive . . . and that have adequate surface energies) which are different and/or have at least two different largest dimensions. Preferably, only grains of the same type (same constituent material, “same largest dimension”) are however found.

The grains, present on at least one portion of the liner/propellant (propellant block) interface, are advantageously present with the portion of their largest dimension that is embedded in the propellant greater than the portion of said largest dimension thereof that is embedded in the bonding layer. Reference has been made to the grains in general (to all the grains) but it is understood that among all the grains present some may not meet the advantageous condition stated. Reference is made more precisely to the majority of the grains (more than 50% by number), or to the great majority of the grains (more than 90% by number). The process for preparation of the loads of the invention is indeed advantageously carried out in order to obtain this advantageous condition (for all the grains) but it is obvious that it could not be excluded that at the end of the implementation of this advantageous variant, some of said grains do not meet said advantageous condition.

The reason for the advantageous nature of this condition is explained below. It is recalled that the propellant contains a low content of polymer, that it therefore has weak adhesive properties. The liner contains a higher content of polymer (HTPB) and therefore has itself better adhesive properties. It is thus advantageous, in order to optimize the action of the grains, for the surface area of said grains in contact with the propellant to be greater than the surface area of said grains in contact with the liner.

In a manner in no way limiting, said advantageous condition is specified. For the majority (more than 50% by number) of the grains, generally the great majority (more than 90% by number) of the grains (or even (virtually) all of the grains), the portion of their largest dimension that is embedded in the propellant is greater, by at least a factor of 2, advantageously by at least a factor of 5, than the portion of said largest dimension thereof that is embedded in the bonding layer.

The grains (specific means for mechanical reinforcement (of the bonding layer/propellant block bond) of the invention), present on at least one portion of the bonding layer/propellant block interface, are generally present at a density (densities) of at least 1 grain/cm² (grains present in various zones of the interface are not necessarily present at the same density). Said grains are generally present (in the zone(s) where they are present, said zone possibly consisting of the entire interface) at a higher density (densities). A person skilled in the art understands that the density of the grains obviously depends on their size and, furthermore, generally, said density of the grains (in the zone(s) where said grains are present) cannot be increased excessively, with reference to the surface area of the propellant/liner contact area.

The grains are present on the whole of said interface or on one portion only thereof. They are present, in a uniform or non-uniform manner, on the whole of said interface or on one portion only thereof. They are opportunely present (in a uniform or non-uniform manner, more generally in a uniform manner) in the zones where the propellant is the most constrained (at the rear end/sleeve and front end/sleeve joining zones), present at a density (d2) greater than their density (d1) in the zones where the propellant is less constrained (at the sleeve) (d1 possibly being equal to 0).

Thus, generally, the density of the grains is greater at the rear end/sleeve and front end/sleeve joining zones.

According to one variant, the grains are not present on the entire bonding layer/propellant block interface. Within the context of this variant, the bonding layer/propellant block interface is (virtually) free of grains at the sleeve of said structure; grains only being present at the rear end/sleeve and front end/sleeve joining zones.

According to its second subject matter, the present invention relates to a process for preparation of a propellant load as described above (propellant load that constitutes the first subject matter of said invention). Said process is a process by analogy, which, characteristically, comprises, at the appropriate time, the deposition of suitable grains. Said process comprises:
providing with a structure of a substantially cylindrical shape with a sleeve, a rear end and a front end; said structure comprising a thermal protection attached to its inner face;
depositing, by spraying, a material, based on hydroxytelechelic polybutadiene (HTPB), precursor of the bonding layer, on said thermal protection;
optionally partially crosslinking said deposited bonding layer precursor material;
depositing grains, made of a suitable material and having suitable dimensions, on said precursor material that is not partially crosslinked or that is partially crosslinked;
optionally completely crosslinking said precursor material that is not partially crosslinked with said grains at its surface, or optionally partially crosslinking said precursor material that is not partially crosslinked with said grains at its surface or optionally complementarily crosslinking said deposited precursor material that is partially crosslinked with said grains at its surface;
casting a precursor material of a propellant, containing energetic charges in a crosslinkable energetic binder comprising a crosslinkable energetic polymer, more polar than hydroxytelechelic polybutadiene (HTPB), and an energetic plasticizer, said polymer representing less than 14% of the volume of said precursor material; and
crosslinking said (cast) precursor material of a propellant (alone), if the precursor material of the bonding layer has been completely crosslinked upstream, or crosslinking said (cast) precursor material of a propellant and complementarily crosslinking the precursor material of the bonding layer that has been partially crosslinked upstream or crosslinking said (cast) precursor material of a propellant and crosslinking the precursor material of the bonding layer that has not been crosslinked upstream, for obtaining a propellant block with said grains at the propellant block/bonding layer interface.

The first step of this process is known per se. It is generally carried out, as already indicated above, according to one or other of the variants specified below. The structure with thermal protection is obtained either by adherisation, drape forming or spraying, of a thermal protection to the inner face of the wall of a pre-existing metallic structure, or by generation of a structure made of a composite material by winding around a thermal protection.

The second step, also known per se, consists of the spraying of the precursor material of the bonding layer (of the liner). Said precursor material comprises said HTPB and at least one crosslinking agent thereof (generally of (poly)isocyanate type). It also advantageously comprises at least one thickening agent, so that its viscosity is increased and it is held, in a stable manner, on the thermal protection.

For the remainder of the process:
according to a first variant, the precursor material of the bonding layer (deposited by spraying) is partially crosslinked before the deposition of the grains. This partial crosslinking increases the viscosity of said material. It makes it possible to control the deposition of the grains with “low” penetration of these grains . . .
according to a second preferred variant (see below), the grains are directly deposited on the precursor material of the bonding layer.

The deposition of the grains is advantageously carried out by spraying these grains on the inside of the structure which is put in rotation (said structure containing the optionally partially crosslinked precursor material of the bonding layer). It is recalled that said deposition of the grains may be carried out, in a uniform or non-uniform manner, on the entire surface of the bonding layer (that is not partially crosslinked or that is partially crosslinked) or on some zones only thereof. Said deposition is advantageously at least carried out at the rear end/sleeve and front end/sleeve joining zones (there where the later cast and crosslinked propellant will be the most constrained). It is understood that the force with which said grains are sprayed and the “state” of the (optionally partially crosslinked) precursor material of the bonding layer into which they are sprayed determine the degree of penetration of said grains into said material.

For the rest, it is also possible to proceed according to various variants: either passing directly to the casting of the precursor material of the targeted propellant (with therefore the deposited bonding layer precursor material that is partially crosslinked or that is not partially crosslinked), or carrying out a crosslinking; complete crosslinking of the deposited bonding layer precursor material, that has not been partially crosslinked upstream, partial crosslinking of the deposited bonding layer precursor material, that has not been partially crosslinked upstream, or complementary crosslinking of said deposited precursor material that has been partially crosslinked upstream.

All these optional crosslinking steps, the optional crosslinking upstream of the deposition of the grains and the optional (complete, partial or complementary) crosslinking downstream of the deposition of the grains, consist of heat treatments or firings.

At this stage of the process, the bonding layer precursor material is either not crosslinked, or partially crosslinked, or completely crosslinked (the bonding layer is then formed), with the grains partly embedded in its surface. Advantageously, it is not crosslinked (see below).

Next, the precursor material of the targeted propellant is cast in the structure (with thermal protection and liner precursor material (which is not crosslinked, partially crosslinked or completely crosslinked (=in that case, the liner), and also grains partially embedded in its surface)). Said precursor material corresponds to the targeted propellant. It contains energetic charges in a crosslinkable energetic binder, comprising a crosslinkable polymer, more polar than hydroxytelechelic polybutadiene (HTPB), an energetic plasticizer and at least one crosslinking agent (generally of (poly)isocyanate type) for said crosslinkable polymer, said crosslinkable polymer (different therefore from HTPB, more polar than HTPB) representing less than 14% by volume. It was indicated above that the energetic plasticizer itself represents, generally, less than 27% of the volume of said precursor material. The portions of the grains not embedded in the liner precursor material (which is not crosslinked, partially crosslinked or completely crosslinked (=in that case, the liner)) are then found embedded in the precursor material of the propellant.

Finally, the cast precursor material of the targeted propellant is crosslinked in situ (suitable heat treatment). The portions of the grains not embedded in the liner precursor material (which is not crosslinked, partially crosslinked or completely crosslinked (=in that case, the liner)) are then found embedded in the propellant. It is understood that the heat treatment that is responsible for the crosslinking of the precursor material of the targeted propellant is jointly responsible for the complete crosslinking of the bonding layer precursor material, if necessary (should no (partial) crosslinking of said bonding layer precursor material have taken place upstream) or the complementary crosslinking of the bonding layer precursor material, partially crosslinked upstream (before or after the deposition of the grains).

The partial crosslinking of the bonding layer precursor material in two steps (before (partial) and after (also partial) the deposition of the grains) is not provided for in the process described above in so far as it appears to not have a great advantage and, in any case, to complicate the preparation of the loads, in particular carried out on an industrial scale. A person skilled in the art understands that it makes it possible however also to obtain loads of the invention and that it could not therefore be excluded from the context of the present invention.

In any case, the embodiment variant according to which the bonding layer precursor material is not crosslinked upstream (of the crosslinking of the precursor material of the propellant), either partially, even less completely, is preferred. Specifically, the joint crosslinking of the bonding layer precursor material and of the precursor material of the propellant is favorable to the optimization of the liner (bonding layer)/propellant adhesion (even in the present context of different polymers, having hardly any affinity, and of a low content of polymer in the propellant).

The grains embedded in part in the liner and in part (their complementary part thereof) in the propellant effectively and long-lastingly reinforce the liner/propellant (propellant block) bond.

It is now proposed to illustrate the invention.

On metal plates, on which a layer of thermal protection (EPDM) had been previously positioned, the precursor of a liner, composed of HTPB, an additive in order to increase its viscosity and a polyisocyanate (isophorone diisocyanate (Vestanat® IPDI from Evonik)) for the subsequent crosslinking thereof, was deposited. A layer having a thickness of around 1 mm was spread manually with a film spreader over the entire surface of the thermal protection. This could have been carried out by spraying.

On this non-crosslinked liner precursor layer of most of these plates, the following were then deposited by sprinkling (this could also have been carried out by spraying):
either polyimide-6 grains (the experiment was carried out several times with grains of various shapes, of various dimensions, deposited at different densities (see table 2 below)),
or SiC grains,
or polyethylene grains (comparative example).

In order to enable a reproducibility of the tests, the amount of grains deposited was previously weighed. Said amount of grains deposited is indicated in the fourth column of table 2 below.

After the deposition of the grains, the plates were pre-cured for 40 h at a temperature of 65° C. Plates without grains (control plates) were treated in the same manner. This heat treatment ensured the crosslinking of the liner precursor.

The propellant paste (of OXALANE® type (energetic binder{=PDEGA polymer+polyisocyanates (hexamethylene diisocyanate trimer (Desmodur® N3300 from Bayer) and diphenylmethane diisocyanate (MDI) (Isonate® M143 from Dow Chemical))+nitrated oil}+charge (comprising ammonium perchlorate, aluminum and octogen)) or of AZALANE® type (energetic binder {=GAP polymer+polyisocyanates (hexamethylene diisocyanate trimer (Desmodur® N3300 from Bayer) and diphenylmethane diisocyanate (MDI) (Isonate® M143 from Dow Chemical))+nitrated oil}+charge (comprising ammonium perchlorate, aluminum and octogen))) was then cast on the liner. Each of the plates (control plates or plates with grains) was then re-cured for 21 days at a temperature of 40° C.

The peel analyses were then carried out according to the AFNOR T70-367 standard.

The results are given in table 2 below. They show the great advantage of the invention.

TABLE 2

| | | | Size: largest | | Amount | | |
|---|---|---|---|---|---|---|---|
| | | | dimension | | g/150 cm² | | |
| Type of propellant | Grains | Geometry | mm | | (***) | | Peel daN/cm |
| OXALANE ® | None | | | | | | 0.4 |
| | Polyamide-6 | Cube | 1.73* | (1) | 3 | (18) | 1.3 |
| | Polyamide-6 | Cube | 2.60* | (1.5) | 5 | (10) | 1.5 |
| | Polyamide-6 | Cube | 3.46* | (2) | 6 | (6) | 1.6 |
| | Polyamide-6 | Cylinder | ≈1** | | 3 | (20) | 1.5 |
| | Polyamide-6 | Cylinder | ≈1.5** | | 4 | (10) | 1.3 |
| | Polyamide-6 | Cylinder | ≈2** | | 6 | (6) | 1.3 |
| | SIC | Milled | 1 | | 20 | (24) | 1.8 |
| | Polyethylene | Cylinder | ≈1.5** | | 10 | (25) | 0.7 |
| AZALANE ® | None | | | | | | 0.1 |
| | Polyamide-6 | Cube | 3.46* | (2) | 5.9 | (5) | 1.6 |
| | Polyamide-6 | Cube | 3.46* | (2) | 11.7 | (9) | 2.1 |

*The largest dimension indicated is that of the diagonal of the cube. The length of the edge of the cube is given between parentheses.
**The largest dimension is substantially equal to the length of the cylinder indicated.
(***)Average number of grains per cm² (expressed as grain/cm²). It is incidentally noted that the “low” peel values, of 1.3 daN/cm, are capable of being increased, by reasonably increasing the amount (the density) of grains deposited.

1. A propellant load comprising:
a propellant block, containing energetic charges in a crosslinked binder, arranged in a structure of a substantially cylindrical shape with a sleeve, a rear end and a front end; said structure having a thermal protection attached to its an inner face of the structure, opposite said block;
a bonding layer, based on crosslinked hydroxytelechelic polybutadiene (HTPB), between said thermal protection and said propellant block; and
means for mechanical reinforcement of the a bonding layer/propellant block bond, wherein:
said crosslinked binder of said propellant block is an energetic binder comprising a polymer, more polar than hydroxytelechelic polybutadiene (HTPB), which is crosslinked and an energetic plasticizer, said polymer non-crosslinked representing less than 14% of the volume of the propellant block; and
said means for mechanical reinforcement of the bonding layer/propellant block bond, which are present on at least one portion of the a bonding layer/propellant block interface, comprise individualized grains embedded in part in said bonding layer and the a complementary part thereof being embedded in said propellant block:
made of a pyrotechnically inert material that is unreactive with respect to the bonding layer and also with respect to the propellant, and that has a surface energy greater than 34 mJ/m²;
a largest dimension of which is between 0.3 and 5.2 mm.

2. The load as claimed in claim 1, wherein said crosslinked polymer of said crosslinked binder of said propellant block is of crosslinked poly(diethylene glycol adipate) (PDEGA) and/or glycidyl azide polymer (GAP) type.

3. The load as claimed in claim 1, wherein a constituent material of said grains is a material selected from polyamide-6, silicon carbide, Kevlar, alumina, melamine resins and urea-formaldehyde resins.

4. The load as claimed in claim 1, wherein, for the majority of the grains, a portion of a largest dimension of the grains that is embedded in the propellant is greater than a portion of said largest dimension of the grains that is embedded in the bonding layer.

5. The load as claimed in claim 1, wherein, for the majority of the grains, a portion of a largest dimension of the grains that is embedded in the propellant is greater, by at least a factor of 2, than a portion of said largest dimension of the grains that is embedded in the bonding layer.

6. The load as claimed in claim 1, wherein said grains, present on at least one portion of the bonding layer/propellant block interface, are present at a density (densities) of at least 1 grain/cm².

7. The load as claimed in claim 1, wherein a density of grains is greater at the rear end/sleeve and front end/sleeve joining zones.

8. The load as claimed in claim 1, wherein said grains are not present on the entire bonding layer/propellant block interface.

9. The load as claimed in claim 1, wherein the bonding layer/propellant block interface is substantially free of grains at the sleeve of said structure; grains only being present at the rear end/sleeve and front end/sleeve joining zones.

10. A process for the preparation of a propellant load as claimed in claim 1, comprising:
providing with a structure of a substantially cylindrical shape with a sleeve, a rear end and a front end; said structure comprising a thermal protection attached to an inner face of the structure;
depositing, by spraying, a material, based on hydroxytelechelic polybutadiene (HTPB), precursor of the bonding layer, on said thermal protection;
optionally partially crosslinking said deposited bonding layer precursor material;
depositing grains, made of a suitable material and having suitable dimensions, on said precursor material that is not partially crosslinked or that is partially crosslinked;
optionally completely crosslinking said precursor material that is not partially crosslinked with said grains at its surface, or optionally partially crosslinking said precursor material that is not partially crosslinked with said grains at its surface or optionally complementarily crosslinking said deposited precursor material that is partially crosslinked with said grains at its surface;
casting a precursor material of a propellant, containing energetic charges in a cross-linkable energetic binder comprising a cross-linkable energetic polymer, more polar than hydroxytelechelic polybutadiene (HTPB), and an energetic plasticizer, said polymer representing less than 14% of the volume of said precursor material of the propellant; and
crosslinking said precursor material of the propellant alone, if the precursor material of the bonding layer has been completely crosslinked upstream, or crosslinking said precursor material of the propellant and complementarily crosslinking the precursor material of the bonding layer that has been partially crosslinked upstream or crosslinking said precursor material of the propellant and crosslinking the precursor material of the bonding layer that has not been crosslinked upstream, for obtaining a propellant block with said grains at a propellant block/bonding layer interface.

11. The process as claimed in claim 10, wherein the structure with thermal protection is obtained either by drape forming or spraying a thermal protection on the inner face of a wall of a pre-existing metallic structure, or by generating a structure made of a composite material by winding around a thermal protection.

12. The process as claimed in claim 10, wherein the grains are sprayed on the inside of the structure put in rotation, said structure containing the optionally partially crosslinked precursor material of the bonding layer.

13. The load as claimed in claim 1, wherein said grains are made of a pyrotechnically inert material that has a surface energy greater than 40 mJ/m².

14. The load as claimed in claim 1, wherein the largest dimension of said grains is between 1.7 and 3.5 mm.

15. The load as claimed in claim 1, wherein the constituent material of said grains is a material selected from polyamide-6 and silicon carbide.

16. The load as claimed in claim 1, wherein, for the majority of the grains, the portion of the largest dimension of the grains that is embedded in the propellant is greater, by at least a factor of 5, than the portion of said largest dimension of the grains that is embedded in the bonding layer.
